(19) United States
(12) Patent Application Publication
(10) Pub. No.: US 2003/0068153 A1
(43) Pub. Date: Apr. 10, 2003

(54) Microhole array, optical fiber array, connector, and microhole array manufacturing method

(75) Inventor: Tomio Suzuki, Yokkaichi-City (JP)

Correspondence Address: BURR & BROWN, PO BOX 7068, SYRACUSE, NY, 13261-7068, US

(73) Assignee: NGK Insulators, Ltd., Nagoya (JP)

(21) Appl. No.: 09/954,712

(22) Filed: Sep. 18, 2001

(30) Foreign Application Priority Data
May 30, 2001 (JP) 2001-162148
Jul. 25, 2001 (JP) 2001-223931

(51) Int. Cl. G02B 6/36

(52) U.S. Cl. 385/137; 385/77

(57) ABSTRACT

There is provided a microhole array with multi-holes for inserting optical fibers therethrough, including: a plurality of tubular sections with holes; and a body base material disposed close to the whole or partial periphery surface of the tubular sections, wherein the tubular sections are made of a resin and the body base material is made of ceramic, glass, metal or their composite. In this microhole array, holes for inserting/fixing optical fibers are arranged with extremely excellent position/size accuracy.

### BACKGROUND OF THE INVENTION AND RELATED ART STATEMENT

The present invention relates to a microhole array permitting optical fibers to be aligned with high accuracy, an optical fiber array comprising the same, a connector used for the connection of optical fibers and a method of manufacturing the microhole array.

In recent years, a planar lightwave circuit (PLC) has been advancing in multicored structure with higher density optical fibers. And, to avoid a large-sized lightwave circuit element in conformity with multicored structure and further attain the promotion of density, development has been made in the direction of shortening a former normal lightwave circuit pitch (250 μm) (e.g., about a half or 127 μm). Furthermore, in conformity with such a higher density optical fiber and shorter lightwave circuit pitch, development has been made in the direction of also shortening the fiber-fiber pitch of an optical fiber array comprising numbers of optical fibers.

In answer to the above promotion of density in optical fibers, one ordinarily uses an optical fiber array of multicored structure comprising numbers of optical fibers and a two-dimensional optical fiber array of optical fibers aligned in two-dimensional directions. These comprise optical fibers aligned at extremely high accuracy in high density.

As an example of system using an optical fiber array, there is a switching system for connecting a light signal to another light signal shown in FIG. 12. This is a system combining an optical fiber array 1 with a mirror array 3 for reflecting the light signals emitted from the optical fibers 2 incorporated in this optical fiber array in a specified direction. Incidentally, the mirror array 3 used here customarily means an optical part with multiple minute movable mirrors 5 disposed two-dimensionally on a silicon substrate 4.

In the above switching system, it is necessary to dispose an optical fiber array, lenses and a mirror array in such a positional relation as to be able to accurately reflect the light signal from an optical fiber and further collect them to another optical fiber. Incidentally, a general optical fiber array used here can be made up by stacking and fixing a plurality of planar optical fiber arrays each comprising optical fibers aligned in a one-dimensional direction.

However, it is extremely difficult and requires a highly advanced technique to stack planar optical fiber arrays while keeping an accurate positional relation between mutual optical fibers. Besides, also in fastening the mutual optical fiber arrays by a manipulation such as adhesion after the completion of stacking, there is also a fear that the position of an optical fiber might shift slightly under the influence of contraction or the like of the adhesive. Thus, in manufacturing an optical fiber array by such a method, there is a problem that high level technique and labor are required.

As one method of aligning optical fibers at good positional accuracy, a method can be suggested to prepare a microhole array 11 comprising 0.126 mmφ holes 10 for inserting optical fibers in advance by drill machining or the like and then inserting and fixing optical fibers into this to manufacture an optical fiber array as shown in FIG. 16. However, the positional accuracy of holes in an ordinary microhole array is required to lie within ±0.002 mm, but it is extremely difficult to have holes satisfying the above positional accuracy provided by drill machining or the like and this cannot be said to be an advisable method also from the viewpoint of production cost.

On the other hand, for example, a manufacturing manner can be suggested to use a mold with multiple pins for making holes disposed internally or the like and pouring a material such as resin into this to integrally mold a microhole array 11 of the shape shown in FIG. 16. However, the error range in the inside diameter of a hole for an ordinary microhole array is required to be lie within ±0.001 mm, but a microhole array made up by the method contracts during the curing of a material such as resin and consequently holes are apt to be deformed in an ellipse or like shapes. Especially holes at the marginal portion have a large contraction ratio and therefore it is difficult to make holes kept within the above error range in certain cases.

Besides, as shown in FIG. 12, an optical fiber array 1 and lenses 6 are generally disposed in a state of coming extremely near but a temperature distribution may rarely occur inside the switching system. Here, whereas the thermal expansion coefficient ranges from 10 to 200 ppm/° C. for a general resin and from 10 to 60 ppm/° C. even in addition of an inorganic filler such as glass fiber, the thermal expansion coefficient of lens ranges approximately from 7 to 10 ppm/° C., so that in a switching system comprising the microhole array obtained by integrally molding a material such as resin, it is also supposed that occurrence of interior temperature distribution disables an accurate transmission of light signals on account of the difference in thermal expansion coefficient between both the materials.

The present invention was made in consideration of such problems pertaining to the prior art and its object is to provide a microhole array with holes for inserting/fixing optical fibers disposed with extremely excellent position/size accuracy which is made of a material low in thermal expansion coefficient, an optical fiber array comprising optical fibers inserted into/fixed to the microhole array, a connector with the ends of aligned optical fibers inside the optical fiber array butted against each other with good positional accuracy and fixed and a method for manufacturing the above microhole array.

### SUMMARY OF THE INVENTION

Namely, according to the present invention, one can provide a microhole array with multi-holes for inserting optical fibers therethrough, comprising a plurality of tubular sections with the above holes and a body base material disposed close to the whole or partial periphery surface of the tubular sections wherein the tubular sections are made of a resin and the body base material is made of ceramic, glass, metal or their composite.

In the present invention, the tubular sections are preferably made of a composite material containing a resin and an inorganic filler in place of the resin and the thermal expansion coefficient of the ceramic, glass, metal or their composite making the body base material is preferably equeLl to or lower than 12 ppm/° C.

In the present invention, the resin is epoxy resin and the inorganic filler is preferably ceramic or glass, 10 ppm/° C. or less in thermal expansion coefficient.

In the present invention, the ceramic, with 10 ppm/° C. or less in thermal expansion coefficient, is preferably amorphous silica and the average grain size of the amorphous silica is 20 μm or smaller.

In the present invention, the thermal expansion coefficient of the tubular sections ranges preferably from 5 to 60 ppm/° C.

Besides, in the present invention, the tubular sections are preferably made by casting a resin or a composite material containing a resin and an inorganic filler and the viscosity of a resin or a composite material containing a resin and an inorganic filler is preferably 10 Pa·s or lower during the casting.

Furthermore, in the present invention, the ceramic, glass, metal or their composite making the body base material is preferably aluminum nitride, mullite, silicon, alumina, silicon nitride, mica, wollastonite, silicon carbide, amorphous silica, borosilicate glass, E glass, soda lime glass, nickel steel, tungsten, molybdenum, stellite, stainless steel, carbon steel, super herd alloy or their composite.

In the present invention, the vicinity of at least one opening face of a hole has a taper portion with the diameter of the above hole gradually increasing toward the opening face of the hole, the taper angle of the taper portion ranges preferably from 15 to 75° and the large-diameter hole and the small-diameter hole are connected preferably at the taper portion.

On the other hand, according to the present invention, one can provide an optical fiber array comprising any of the above microhole arrays.

Furthermore, according to the present invention, one can provide a connector with two or more guide holes for inserting guide pins therethrough which is used to butt the ends of corresponding optical fibers against each other before the connection, wherein any of the above microhole arrays is provided with the guide holes and simultaneously two or more tubular sections made of a resin are provided in parallel with multi-holes for inserting optical fibers therethrough.

In the present invention, the tubular sections are preferably made of a composite material containing a resin and an inorganic filler in place of the resin, further the resin is epoxy resin and the inorganic filler is preferably ceramic, with 10 ppm/° C. or less in thermal expansion coefficient.

In the present invention, the thermal expansion coefficient of the tubular sections ranges preferably from 5 to 60 ppm/° C.

Besides, in the present invention, the tubular sections are preferably made by casting a resin or a composite material containing a resin and an inorganic filler and the viscosity of a resin or a composite material containing a resin and an inorganic filler is preferably 10 Pa·s or lower during the casting.

Furthermore, according to the present invention, one can provide a method for manufacturing a microhole array with multi-holes for inserting optical fibers therethrough, comprising the steps of disposing a first mold and a second mold having a plurality of guide holes so as to oppose the opening faces of the relevant guide holes against each other, disposing a body base material having a plurality of primary holes between the first and second molds disposed and simultaneously inserting gauge pins into guide holes of the first mold, primary holes of the body base material and guide holes of the second mold, next not only pouring a molding material into the gap between the first mold and the body base material but also filling the molding material into the gaps between the gauge pins and the primary holes by reducing the pressure in the gap between the second mold and the body base material to cure the filled molding material, then extracting the gauge pins and at the same time releasing the body base material from the molds to obtain a release product and removing the surplus cured molding material from the obtained release product.

In the present invention, it is preferable to pour a molding material, 10 Pa·s or less in viscosity.

### BRIEF DESCRIPTION OF THE DRAWINGS

FIG. 1 is a perspective view typically showing one embodiment of a two-dimensional microhole array according to the present invention.

FIG. 2 is an enlarged view of the A portion in FIG. 1.

FIG. 3 is a partially enlarged view showing another embodiment of a microhole array according to the present invention.

FIG. 4 is a partially enlarged view showing yet another embodiment of a microhole array according to the present invention.

FIG. 5 is a partially enlarged view showing yet another embodiment of a microhole array according to the present invention.

FIG. 6 is a partially enlarged view showing yet another embodiment of a microhole array according to the present invention.

FIG. 7 is a partially enlarged view showing yet another embodiment of a microhole array according to the present invention.

FIG. 8 is a partially enlarged view showing yet another embodiment of a microhole array according to the present invention.

FIG. 9 is a partially enlarged view showing yet another embodiment of a microhole array according to the present invention.

FIG. 10 is a partially enlarged view showing yet another embodiment of a microhole array according to the present invention.

FIG. 11 is a partially enlarged view showing yet another embodiment of a microhole array according to the present invention.

FIG. 12 is a typical view illustrating a switching system for a connecting a light signal to another light signal.

FIG. 13 is a perspective view typically showing one embodiment of a connector according to the present invention.

FIGS. 14 (a) to 14 (e) are illustrations showing a method for manufacturing a microhole array according to the present invention.

FIG. 15 is a perspective view typically showing one embodiment of body base material according to the present invention.

FIG. 16 is a perspective view typically showing one embodiment of a conventional two-dimensional microhole array.

### DESCRIPTION OF PREFERRED EMBODIMENT

The embodiments of the present invention will be described below. The present invention is not limited to the embodiments described below, but it should be understood that modifications, improvements or the like falling within the limits and bounds not departing from the purport of the present invention may be fittingly made on the basis of the knowledge of those skilled in the art.

A microhole array according to the present invention comprises a plurality of tubular sections with holes for inserting optical fibers therethrough and a body base material disposed close to the whole or partial periphery surface of the tubular sections, where the tubular sections are made of a resin and the body base material is made of any of ceramic, glass and metal or their composite. Hereinafter, a microhole array according to the present invention will be described in detail.

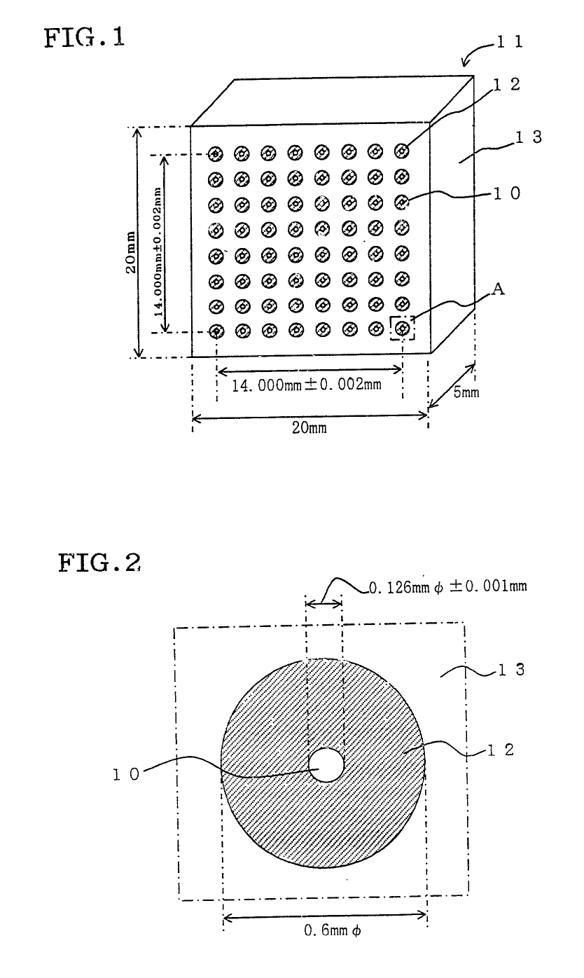

FIG. 1 is a perspective view typically showing one embodiment of a microhole array according to the present invention and FIG. 2 is an enlarged view of the A portion in FIG. 1, showing the situation comprising a tubular section 12 with a hole 10 for inserting optical fibers therethrough and a body base material 13 disposed close to the whole periphery surface of the tubular section. Here, the tubular section 12 is made of a resin, i.e. a plastic cured under suitable conditions. Since such a resin is good in moldability and low in contractility, the relevant tubular section 12 has a hole 10 of excellent positional accuracy.

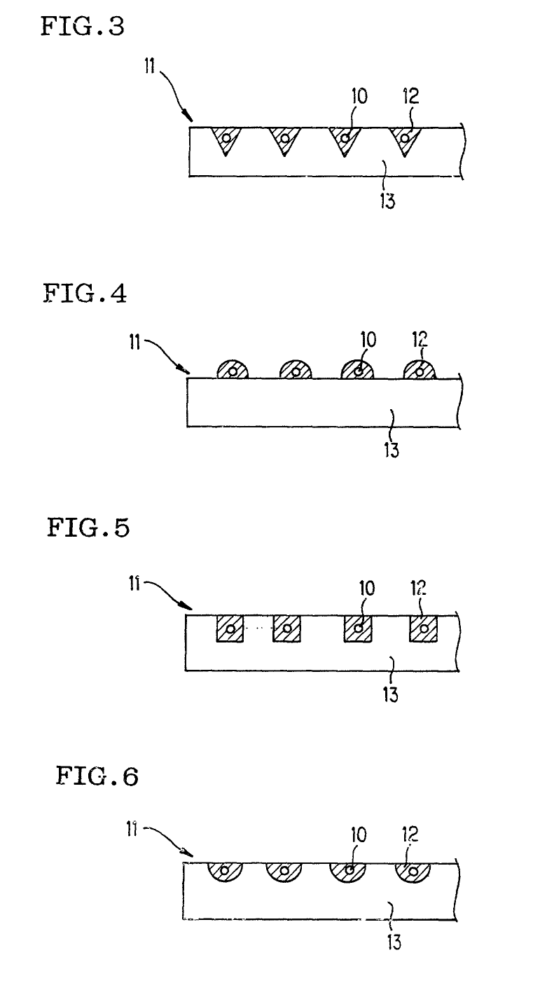

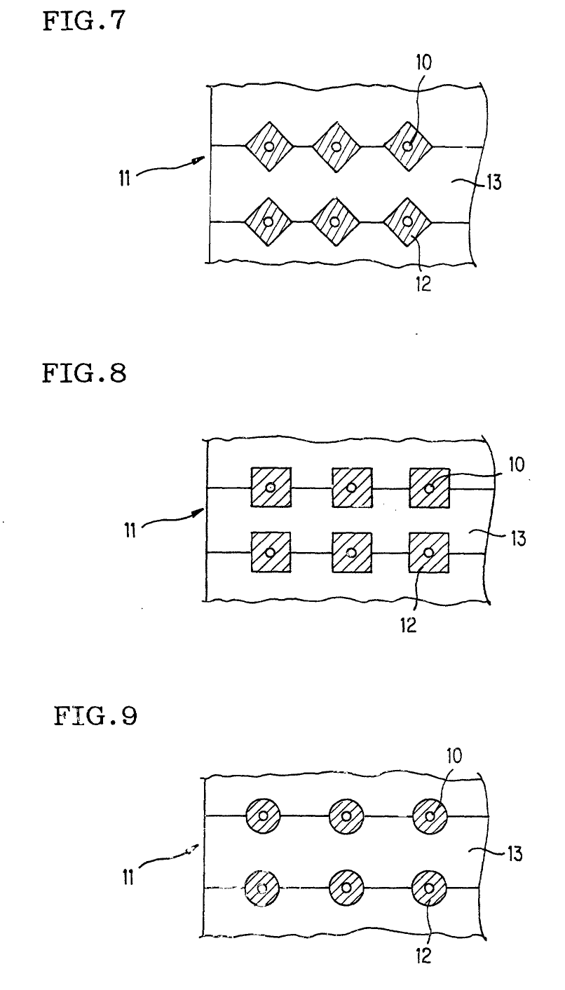

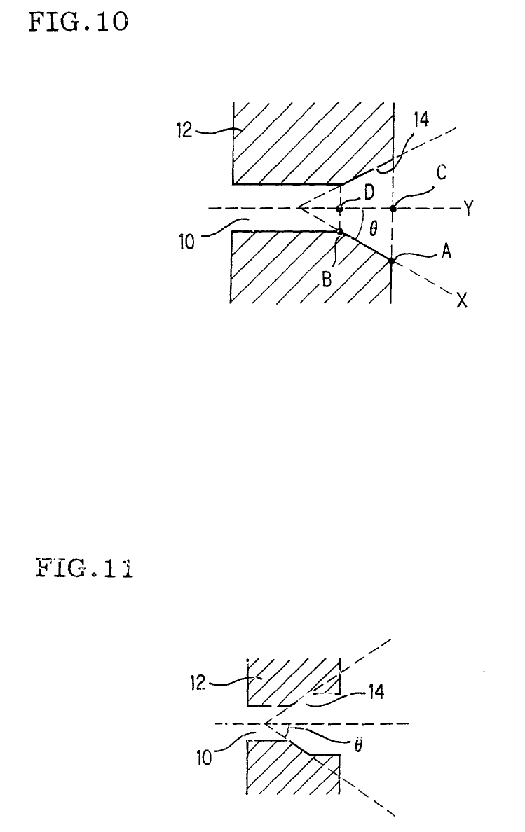

FIGS. 3 to 6 are partially enlarged views showing other embodiments of a microhole array according to the present invention, showing the situation comprising tubular sections 12 with holes 10 for inserting optical fibers therethrough and a body base material 13 disposed close to the partial periphery surface of the tubular sections. Namely, the present invention is not limited to those with the opening faces of holes arranged in two-dimensional directions as shown in FIG. 1, but may be practicized also in those with the opening faces of holes arranged in one-dimensional direction. Furthermore, even in structures comprising a plurality of body base materials stacked and fixed in a one-dimensional direction as shown in FIGS. 7 to 9, the effect of the present invention can be manifested.

Besides, in a microhole array according to the present invention, the body base material is made of any of ceramic, glass and metal or their composite combined from two or more of these. Specifically, the thermal expansion coefficient of the microhole array according to the present invention is closer to that of a lens (7 to 10 ppm/° C.) than to the thermal expansion coefficient of the microhole array obtained by integrally molding a material such as a resin (that of the resin (especially, in case of adding an inorganic filler or the like): 10 to 60 ppm/° C.) Thus, even if a temperature distribution takes place inside the switching system, an accurate positional relation between the microhole array and lenses is maintained and inconveniences such as transmission hindrance of light signals originating from the difference of thermal expansion coefficient between both materials is unlikely to occur.

Besides, in the present invention, the material of a tubular section is preferably made not only of a resin but also of a composite material containing a resin and an inorganic filler. The “composite material containing a resin and an inorganic filler” means a composite material with an inorganic filler dispersed in the matrix of a plastic obtained by curing a resin under suitable conditions. The composite material having such a material composition is better in moldability and lower in contractility, so that the tubular section made, thus has holes excellent in positional accuracy.

Furthermore, from the viewpoint of more accurately maintaining the positional relation between a microhole array and lenses in the present invention, the thermal expansion coefficient of ceramic, glass, metal or their composite making the body base material is preferably 12 ppm/° C. or lower, more preferably 10 ppm/° C. or lower and especially preferably 1 to 10 ppm/° C.

Besides, in the present invention, it is preferable that the resin contained in the composite material making up the above tubular section is epoxy resin and the inorganic filler is a ceramic or glass, 10 ppm/° C. or less in thermal expansion coefficient. This is because epoxy resin is not only chemically stable but also exhibits a good fluidity during the molding. Besides, because of inhibiting the thermal expansion of the epoxy resin serving for the matrix of the composite material making a tubular section, use of ceramic or glass, 10 ppm/° C. or less in thermal expansion coefficient, i.e. moderate in thermal expansion coefficient, is preferable. Specifically, amorphous silica, 0.5 ppm/° C. in thermal expansion coefficient, cordierite, 1.0 ppm/° C. in thermal expansion coefficient, β-eucriptite, −8 ppm/° C. in thermal expansion coefficient and so on can be used adequately.

Preferable as the plastic serving for the matrix of the tubular section of a microhole array according to the present invention is a plastic resulting from epoxy resin, especially glycidyl ether type of main agent, cured with a curing agent (i.e. cured epoxy resin).

Adequate as glycidyl ether type epoxy resin serving for the main agent is bisphenol A type epoxy resin and its epoxy equivalent ranges preferably from 150 to 250. This is because the plastic after the curing is hard and becomes too fragile for an epoxy equivalence of below 150 while it reaches no moderate hardness for an epoxy equivalence of above 250 and the glass transition point Tg also descends.

Besides, in the present invention, the above glycidyl ether type epoxy resin is preferably bisphenol A type epoxy resin and/or novolak type epoxy resin. When bisphenol A type epoxy resin alone is used as the main agent, the glass transition point Tg of the plastic cured with a curing agent rangas approximately from 100 to 150° C. In need of elevating Tg, use of novolak type epoxy resin is preferable. Besides, in the plastic made by curing a mixture of bisphenol A type epoxy resin and the above novolak type epoxy resin, the glass transition point Tg can be set optionally.

Besides, since in holes of the tubular section optical fibers are disposed and inserted/fixed, the ceramic is preferably have fine grain structure from the viewpoint of reducing the influence on the relevant optical fibers to a possible minimum. Specifically, an average grain size of 20 μm or smaller and at once a maximum grain size of 50 μm or smaller is preferable, while an average grain size of 5 μm or smaller and at once a maximum grain size of 15 μm or smaller is more preferable. Incidentally, the lower limit of average grain size of the ceramic is preferably on the order of about 0.5 μm. Besides, to disperse a great amount of the ceramic in a matrix, the shape of grains is preferably globular. Since those of these grain size and shape are easy to obtain at a practical level, amorphous silica is most suitable.

In the present invention, the thermal expansion coefficient of tubular sections ranges preferably from 5 to 60 ppm/° C. and is more preferably isotropic. Namely, on account of no mismatch to a body base material and excellency in adhesion between the body base material and the tubular section, a microhole array with a high positional accuracy maintained concerning holes for inserting/fixing optical fibers is obtainable.

In the present invention, tubular sections are preferably made by casting a resin or a composite containing a resin and an inorganic filler. Because of making tubular sections by casting, they have a merit of excellency in workability and adaptability both to a minute shape and a complicated shape.

Besides, in the present invention, the viscosity of a resin or a composite containing a resin and an inorganic filler during the casting is preferably 10 Pa·s or lower, more preferably 8 Pa·s or lower and especially preferably 7 Pa·s or lower. To form a tubular section by a molding process using the casting, it is important that a resin or a composite exhibits a viscosity enabling the cast molding. For this purpose, the fluidity of a material is insufficient and the cast molding becomes difficult if the viscosity of a material during the casting exceeds 10 pa·s. Thus, by setting the viscosity of a material at the relevant value or lower, a sufficient fluidity can be secured during the casting.

In the present invention, no special restriction is imposed on the lower limit of the above viscosity, but the viscosity is desired to be 0.1 mPa·s or higher if substantial manufacturing conditions and the like are taken into consideration. Incidentally, to measurements of viscosity, E model rotating viscometer of cone plate type can be applied.

In this measuring method, first, the liquid contact portion between a material and a viscometer is set to a given temperature in advance and approximately 0.5 ml of the liquid to be measured (material) is put between the cone plates.

Next, after the liquid to be measured is brought into temperature equilibrium with the measuring jig (approximately one minute), the viscometer is rotated at 50 rpm and the value obtained after one-minute rotation is to be set to a measured viscosity value.

Besides, in the present invention, as shown in FIG. 10, the vicinity of one opening face in a hole 10 has a taper 15 portion 14 with the diameter of the hole 10 gradually increasing toward the opening face of the hole 10, the taper angle θ of the taper portion 14 ranges preferably from 15 to 75° and further a structure that the large-diameter hole and the small-diameter hole are connected at the taper portion 14 is allowable as shown in FIG. 11. Due to this, insertion of optical fibers into holes 10 is extremely facilitated.

Incidentally, in FIG. 10, the “taper angle” mentioned in the present invention means an angle θ made by the crossing of the straight line X tying any point A on the verge of the large-diameter hole with any point B shortest in distance to this point on the verge of the small -diameter hole and the straight line Y tying the center point C of the large-diameter hole with the center point D of the small-diameter hole. Besides, the “center point” means the center of a circle in case of a circle, the crossing of the long diameter and the short diameter in case of an ellipse and the crossing of both diagonals in case, of a regular square and a rectangle. Furthermore, in case of an indefinite polygon, it is defined as the center of gravity on assuming this indefinite polygon to be a thin sheet having a mass.

As described hitherto, a microhole array according to the present invention is characterized in that the size/position accuracy of holes for inserting/fixing optical fibers is extremely good and moreover the thermal expansion coefficient is low even it a composite containing a resin is used. And, an optical fiber array as another aspect of the present invention, comprising such a microhole array is fabricated by inserting/fixing optical fibers into/to holes extremely good in size/position accuracy in accordance with a typical method and accordingly the optical fibers are arranged with extremely good size/position accuracy.

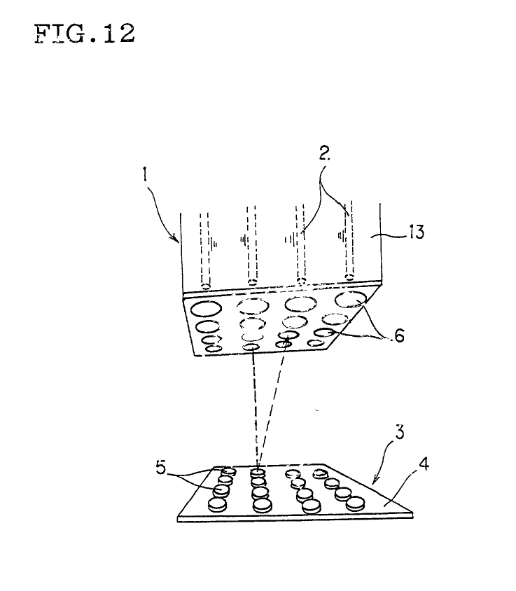

Besides, even if a temperature distribution occurs inside the system when applying an optical fiber array according to the present invention to a switching system for connecting a light signal to another light signal as shown in FIG. 12, an accurate positional relation between optical fibers 2 and lenses 6 are maintained and an accurate transmission of a light signal is secured because the thermal expansion coefficient of lenses 6 approximates to that of a body base material 13 making up an optical fiber array 1.

Besides, still another aspect of the present invention is a connector with two or more guide holes for inserting guide pins therethrough used to butt the ends of corresponding optical fibers against each other before the connection, characterized in that two or more guide holes made by closely making tubular sections made of a resin on the periphery surface are provided at the microhole array described above in parallel with multi-holes for inserting optical fibers therethrough.

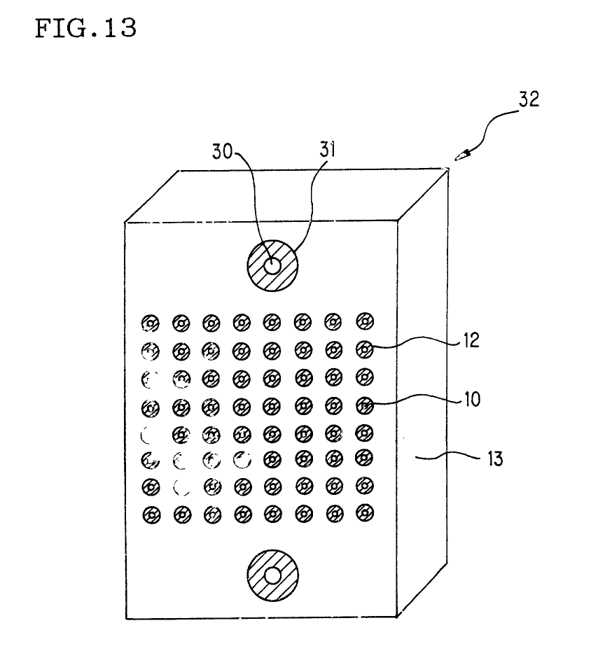

FIG. 13 is a perspective view typically showing one embodiment of a connector according to the present invention, illustrating an arrangement that multi-holes 10 for inserting optical fibers therethrough and two tubular sections 31 each with a guide hole 30 for inserting a guide pin therethrough are provided so that they are in parallel with each other.

The tubular section 31 provided with a guide hole 30 inside is made of a resin, i.e. a plastic cured under suitable conditions, such a resin is good in molding and low in contractility and accordingly the guide hole 30 is extremely excellent in positional accuracy. Thus, in mutual connection of optical fiber arrays, the ends of corresponding optical fibers a ligned in the optical fibers can be butted against each other and fixed at good positional accuracy.

Incidentally, although FIG. 13 shows a two-dimensional arrangement of opening faces of holes 10 for inserting optical fibers, a connector according to the present invention is not limited to such an embodiment, but a simple one-dimensional arrangement of holes is allowable.

In the present invention, the composing material of a tubular section is not only a resin but the tubular section is also preferably made of a composite material containing a resin and an inorganic filler. Since the composite material having such a material composition is better in moldability and lower in contractility, the guide holes 30 of the connector 32 shown in FIG. 13 are extremely good in positional accuracy.

Besides, in the present invention, the resin contained in the composite material constituting the tubular section internally provided with a guide hole is epoxy resin and the inorganic filler is preferably ceramic, 10 ppm/° C. or less in thermal expansion coefficient. This is because epoxy resin is not only chemically stable but exhibits a good fluidity also during the molding. Because of inhibiting the thermal expansion of epoxy resin serving for the matrix of a composite material making a tubular section, use of a ceramic, 10 ppm/° C. or less in thermal expansion coefficient, moderately low in thermal expansion coefficient, is preferable. Specifically, amorphous silica, 0.5 ppm/° C. in thermal expansion coefficient, cordierite, 1.0 ppm/° C. in thermal expansion coefficient, β-eucryptite, −8 ppm/° C. in thermal expansion coefficient and so on can be used adequately.

Preferably, the plastic serving as the matrix of a tubular section internally provided with a guide hole of a connector according to the present invention is the plastic resulting from epoxy resin, in particular glycidyl ether type epoxy resin of main agent, cured with a curing agent (i.e. cured epoxy resin).

Adequate as glycidyl ether type epoxy resin serving for the main agent is bisphenol A type epoxy resin and its epoxy equivalent ranges preferably from 150 to 250. This is because the plastic after the curing is hard and becomes too fragile for an epoxy equivalence of below 150 while on the other hand it reaches no moderate hardness for an epoxy equivalence of above 250 and the glass transition point Tg also descends.

Besides, in the present invention, the above glycidyl ether type epoxy resin is preferably bisphenol A type epoxy resin and/or novolak type epoxy resin. When bisphenol A type epoxy resin alone is used as the main agent, the glass transition point Tg of the plastic cured with a curing agent ranges approximately from 100 to 150° C. In need of elevating Tg, use of novolak type epoxy resin is preferable. Besides, in the plastic made by curing a mixture of bisphenol A type epoxy resin and the above novolak type epoxy resin, the glass transition point Tg can be set optionally.

In the present invention, the thermal expansion coefficient of tubular sections internally provided with guide holes ranges preferably from 5 to 60 ppm/° C. and is more preferably isotropic. Namely, on account of no mismatch to a body base material, excellency in adhes-on between the body base material and the tubular section, and guide holes with a high positional accuracy a connector is used to butt the ends of corresponding optical fibers against each other before the connection obtainable.

Besides, in the present invention, tubular sections are preferably made by casting a resin or a composite containing a resin and an inorganic filler. Because of making tubular sections by casting, they have a merit of excellency in workability and adaptability both to a minute shape and a complicated shape.

Furthermore, in the present invention, the viscosity of a resin or a composite containing a resin and an inorganic filler during the casting is preferably 10 Pa·s or lower, more preferably 8 Pa·s or lower and especially preferably 7 Pa·s or lower. To form a tubular section by a molding process using the casting, it is important that a resin or a composite exhibits a viscosity enabling the cast molding. For this purpose, the fluidity of a material is insufficient and the cast molding becomes difficult if the viscosity of a material during the casting exceeds 10 Pa·s. Thus, by setting the viscosity of a material at the relevant value or lower, a sufficient fluidity can be secured during the casting.

In the present invention, no special restriction is imposed on the lower limit of the above viscosity, but the viscosity is desired to be 0.1 mPa·s or higher if substantial manufacturing conditions and the like are taken into consideration.

Next, referring to the drawings, a method for manufacturing a microhole array according to the present invention will be described.

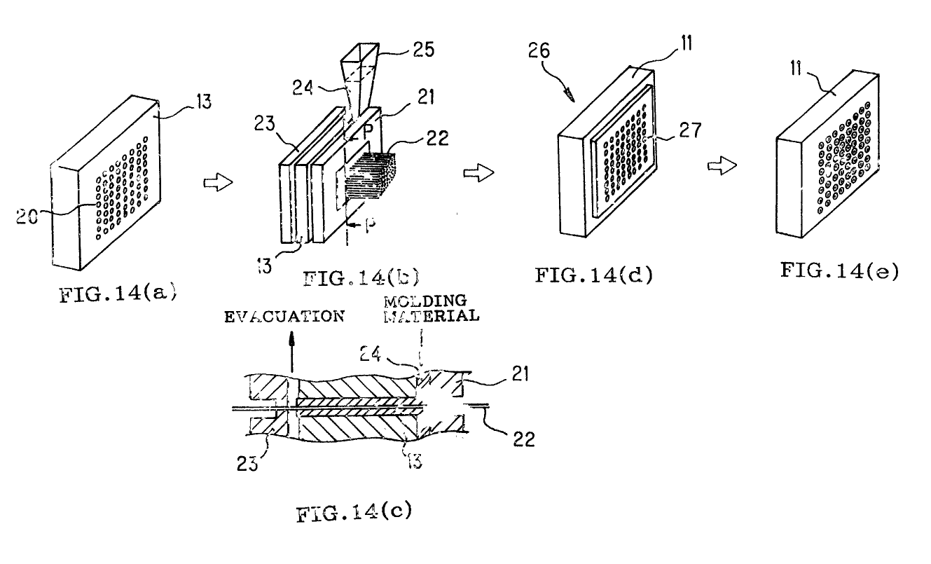

FIGS. 14(a) to 14(e) are illustrations showing a method for manufacturing a microhole array according to the present invention. First, the first mold 21 and the second mold 23 with a plurality of guide holes (unillustrated) are disposed so as to keep opening faces of the holes for inserting their respective guide pins opposed to each other and a body base material 13 with a plurality of primary holes 20 is disposed between the first mold 21 and the second mold 23 (FIGS. 14(a) and 14(b)).

Next, through guide holes of the first mold 21 and primary holes of the, body base material 13 into guide holes of the second mold 23, gauge pins 22 are inserted. By not only pouring a molding material 24 into the gap between the first mold 21 and the body base material 13 but also reducing the pressure in the gap between the second mold 23 and the body base material 13, the molding material 24 is filled into the gap between the gauge pins 22 and the primary holes (FIGS. 14(b) and 14(c)). Incidentally, FIG. 14(c) is a sectional view taken along line P-P of FIG. 14(b). Subsequently, after curing the filled molding material 24 under suitable conditions, the gauge pins 22 are extracted and at the sane time the body base material 13 is released from a mold to obtain a release product 26 (FIG. 14(d)). By removing the surplus cured molding material 27 from this release product 26, a microhole array 11 according to the present invention can be manufactured (FIG. 14(e)).

Body base materials include any of ceramics, glass and metals or composites combined from two or more of these., Furthermore, in the present invention, ceramic, glass, metal or their composites are preferably aluminum nitride, mullite, silicon, alumina, silicon nitride, mica, wollastonite, silicon carbide, amorphous silica, borosilicate glass, E glass, soda lime glass, nickel steel, tungsten, molybdenum, stellite, stainless steel, carbon steel, super hard alloy or their composite. Preferably, the aluminum nitride is aluminum nitride based machinable ceramics. This is because they are low in thermal expansion coefficient and holes can be easily machined by drill machining or the like.

First, as shown in FIG. 14(a), a body base material 13 is drilled in a given size and at given intervals of arrangement to dispose primary holes 20. Drilling of this time may be made in accordance with a typical method and holes may be provided by the drill machining or the like. Incidentally, primary holes larger in diameter than the holes for inserting/fixing optical fibers are provided. Specifically, it is only necessary to set the diameter of primary holes to twice to ten times that of desired holes and to 3/4 to 1/4 of the pitch of desired holes. At this time, the position/size accuracy of within ±0.001 mm substantially required at holes for inserting/fixing optical fibers need not be attained at primary holes and they have only to be provided in a position/size accuracy of within about ±0.05 mm.

Besides, the shape of primary holes is not limited to a circle, but may also be an ellipse, a polygon, or the other. Furthermore, Primary holes are not limited to those provided by drilling such as drill machining or the like as mentioned above, but, for example, groove sections of suitable intervals, depth and shape are provided in a substrate made of a given material, then the face with the groove sections made thereon and the pertinent planar sections of another member with planar sections may be butted against each other to form primary holes. By using the body base material with primary holes made like this, a microhole array 11 of such a structure as shown in FIGS. 3 to 6 can be manufactured.

Next, as shown in FIG. 14(b), a first mold 21 and a second mold 23 with holes (unillustrated) drilled at a given size and at given intervals are so disposed that the faces with holes provided are opposed to each other and a body base material 13 with the above primary holes is disposed between these molds. After the disposition, gauge pins 22 satisfying a given size accuracy are made to pass through holes of the first mold 21, primary holes of the body base material 13 and holes of the second mold 23. Since the size accuracy of the gauge pins 22 used at this time and the size/position accuracy of holes of each mold are reflected on the size/position accuracy of holes for inserting/fixing optical fibers, a size/position accuracy of within ±0.0005 mm must be satisfied. Incidentally, the diameter of gauge pins 22 is, needless to say, smaller than that of primary holes of each mold and the diameter of primary holes in each mold is advisable to be twice to ten times that of gauge pins.

Then, from the top of FIG. 14(b) into the gap between a first mold 21 and a body base material 13, a molding material containing suitable additives beginning with a resin, or a mixture of a resin and an inorganic filler and other curing agents are poured so as to be filled between gauge pins 22 and primary holes. Incidentally, when pouring the molding material, the gap between a second mold 23 and a body base material 13 is evacuated to make a suitable reduced pressure state in order to prevent gas from remaining in the primary hole (FIG. 14(c)). Furthermore, in case of a high viscosity of the molding material, pressuring the molding material is also preferable.

Incidentally, by curing the resin in the molding material to make a plastic thereafter, tubular sections are made of the molding material. The first mold 21, the second mold 23 and the gauge pins 22 are removed to obtain a release product 26 as shown in FIG. 14(d). By subjecting this to polishing and other like treatments, the surplus cured molding material 27 is removed and a microhole array 11 according to the present invention as shown in FIG. 1 can be fabricated.

In a method for manufacturing a microhole array according to the present invention, the molding material, 10 Pa·s or less in viscosity, is preferably poured, the molding material, 8 Pa·s or less in viscosity, is more preferably poured and the molding material, 7 Pa·s or less in viscosity, is especially preferably poured. To form tubular sections by molding based on pouring a molding material into a given mold, or so-called casting, it is important that a resin or a composite material exhibits a viscosity permitting the cast molding. For this purpose, the fluidity of a molding material is insufficient and the cast molding becomes difficult if its viscosity during the casting exceeds 10 Pa·s. Thus, by setting the viscosity of the molding material to the relevant value or lower, a sufficient fluidity can be secured in case of casting.

In the present invention, no special restriction is imposed on the lower limit of the above viscosity, but a viscosity of not lower than 0.1 mpa·s is only necessary if substantial manufacturing conditions are taken into consideration.

Incidentally, in case of making a tubular section by casting, the curing agent for curing a resin is preferably a curing agent, high in fluidity during the casting, relatively slow in curing reaction and containing no solvent.

The curing agents satisfying such conditions includes anhydrides such as, e.g. phthalic anhydride, tetrahydromethyl phthalic anhydride, hexahydro phthalic anhydride, trimellitic anhydride, methyl nadic anhydride and terpene acid anhydride. Incidentally, in addition to the main agent, curing agent and inorganic filler, a curing accelerator, a coupling agent, a flame retarder and so on can be appropriately added if necessary.

Incidentally, to manufacture a microhole array of such a structure as shown in FIGS. 10 and 11, i.e. having a taper portion 14, for example, a method for subjecting the tubular section 12 of a microhole array 11 of such a structure as shown in FIG. 1 obtained by the above manufacturing method to drill machining or whetstone machining, a method for making a taper portion at the stage of curing a molding material by using stepped taper pins or the like rather than ordinary gauge pins or other like methods are suitably adopted.

On the other hand, a connector according to the present invention can be manufactured in a way similar to the method for manufacturing a microhole array according to the present invention. Namely, it is only necessary to use a body base material having two or more primary holes for making guide holes in addition to a plurality of primary holes and a mold corresponding to this. The diameter of two or more primary holes for making guide holes has only to be twice to ten times that of desired guide holes and they have only to be disposed in a position/size accuracy of within almost ±0.05 mm.

Hereinafter, referring to the embodiments, the present invention will be further described specifically.

First Embodiment:

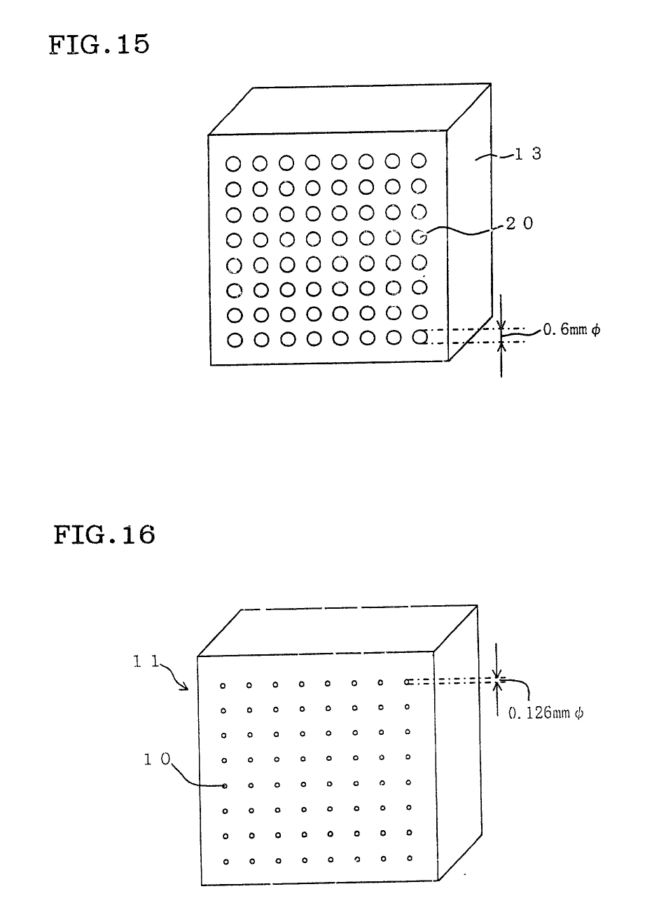

A body base material (thermal expansion coefficient: 3 ppm/° C. ; 20 mm×20 mm×5 mm) made of aluminum nitride was prepared and 64 primary holes 20 of 0.6 mmφ in total were provided by drill machining as shown in FIG. 15. Next, first and second molds (material: invar; thermal expansion coefficient: 3 ppm/° C.) 21 and 23 having holes (unillustrated) drilled (wire discharge machining) in a given size and at given intervals of arrangement) as shown in FIG. 14(b), were disposed so that the faces with holes provided thereon, were opposed to each other and the body base material 13 with the above primary holes was disposed between these molds. After the disposition, gauge pins 22 (0.126 mmφ±0.0005 mm) were made to pass through holes of the first mold 21 and primary holes of the body base material 13 into holes of the second mold 23.

100 parts by weight of bisphenol A type epoxy resin as a resin, 110 parts by weight of a cyclo-aliphatic anhydride as a curing agent, 0.5 part by weight of imidazole as a curing accelerator, 320 parts by weight of globular amorphous silica, 1 μm in average grain diameter, one part by weight of amino-based silane coupling agent and 95 parts by weight of hexabromobenzene as a flame retarder were thrown respectively into a stirring vane-type mixer and mixed at 80° C. This mixture (molding material) was poured into the gap between the first mold 21 and the body base material 13 under suitable reduced pressure conditions and casted.

Thereafter, by heating at 80° C. for 3 hr, then at 130° C. for 12 hr, the resin was cured. After the cooling, the gauge pins 22 were extracted and at the same time the body base material 13 was taken out from the first mold 21 and the second mold 23 (FIG. 14(c)) and the surplus molding material was removed to fabricate a microhole array 11 (FIG. 14(e)). The size and various physical properties of the obtained microhole array 11 are shown in Table 1.

TABLE 1

| Disposition of Holes | 8 × 8 (pieces) |
|---|---|
| Pitch of Holes | 1.25 mm × 1.25 mm ± 0.002 mm |
| Hole Diameter | 0.126 mm ± 0.001 mm |
| Thermal Expansion Coefficient | 3 ppm/° C. |

Considerations:

As shown in Table 1, it could be confirmed in a microhole array according to the present invention that the holes for inserting/fixing optical fibers were arranged with extremely good position/size accuracy.

Since a microhole array according to the present invention comprises tubular sections made of a given material and a body base material made of a low thermal expansion coefficient ceramic or the like as described above, holes for inserting/fixing optical fibers arranged with extremely excellent position/size accuracy.

Besides, since an optical fiber array according to the present invention is manufactured by inserting/fixing optical fibers into/to the above microhole array, the optical fibers are arranged with extremely good position/size accuracy. Besides, because of being made up of a low thermal expansion coefficient material, the optical fiber array is incorporated into a switching system for connecting a light signal to another light signal, which incorporation secures an accurate transmission of light signals even if a temperature distribution occurs inside the system.

Furthermore, since guide holes are provided at the above microhole array and moreover tubular sections made of a given material are provided in parallel with multi-holes for inserting optical fibers therethrough in a connector according to the present invention, the guide holes are arranged with extremely good position/size accuracy and the ends of corresponding optical fibers can be butted against each other and fixed with good positional accuracy.

Besides, based on a method for manufacturing a microhole array according to the present invention, the microhole array with holes for inserting/fixing the above optical fibers arranged with extremely excellent position/size accuracy can be manufactured easily and at low cost.

What is claimed is:

1. A microhole array with multi-holes for inserting optical fibers therethrough, comprising: a plurality of tubular sections with said holes; and a body base material disposed close to the whole or partial periphery surface of the tubular sections, wherein the tubular sections are made of a resin and the body base material is made of ceramic, glass, metal or their composite.

2. The microhole array as set forth in claim 1, wherein the tubular sections are made of a composite material containing a resin and an inorganic filler in place of the resin.

3. The microhole array as set forth in claim 1, wherein the thermal expansion coefficient of the ceramic, glass, metal or their composite making the body base material is equal to or lower than 12 ppm/° C.

4. The microhole array as set forth in claim 2, wherein the resin is epoxy resin and the inorganic filler is ceramic or glass, 10 ppm/° C. or less in thermal expansion coefficient.

5. The microhole array as set forth in claim 4, wherein the ceramic having, 10 ppm/° C. or less in thermal expansion coefficient, is amorphous silica.

6. The microhole array as set forth in claim 5, wherein the average grain size of the amorphous silica is 20 μm or smaller.

7. The microhole array as set forth in claim 1, wherein the thermal expansion coefficient of the tubular sections ranges from 5 to 60 ppm/° C.

8. The microhole array as set forth in claim 1, wherein the tubular sections are made by casting a resin or a composite material containing a resin and an inorganic filler.

9. The microhole array as set forth in claim 8, wherein the viscosity of a resin or a composite material containing a resin and an inorganic filler is 10 Pa·s or lower during the casting.

10. The microhole array as set forth in claim 1, wherein ceramic, glass, metal or their composite making the body base material are aluminum nitride, mullite, silicon, alumina, silicon nitride, mica, wollastonite, silicon carbide, amorphous silica, borosilicate glass, E glass, soda lime glass, nickel steel, tungsten, molybdenum, stellite, stainless steel, carbon steel, super hard alloy or their composite.

11. The microhole array as set forth in claim 1, wherein the vicinity of at least one opening face of a hole has a taper portion with the diameter of said hole gradually increasing toward the opening of the hole and the taper angle of the taper portion ranges from 15 to 75°.

12. The microhole array as set forth in claim 11, wherein large-diameter holes and small-diameter holes are connected at the taper portion.

13. An optical fiber array with optical fibers inserted into/fixed to multi-holes made in a microhole array, said microhole array comprising:
a plurality of tubular sections with holes; and a body base material disposed close to the whole or partial periphery surface of the tubular sections, wherein the tubular sections are made of a resin and the body base material is made of a ceramic, glass, a metal or their composite.

14. A connector with two or more guide holes for inserting guide pins therethrough which is used to butt the end of an optical fiber against that of another before the connection, said guide holes being provided at a microhole array comprising: a plurality of tubular sections with holes for inserting optical fibers therethrough; and a body base material disposed close to the whole or partial periphery surface of the tubular sections wherein the tubular sections are made of a resin and the body base material is made of ceramic, glass, metal or their composite, and moreover two or more tubular sections made of a resin being provided in parallel with multi-holes for inserting optical fibers therethrough.

15. The connector as set forth in claim 14, wherein the tubular sections are preferably made of a composite material containing a resin and an inorganic filler in place of the resin.

16. The connector as set forth in claim 15, wherein the resin is epoxy resin and the inorganic filler is a ceramic, 10 ppm/° C. or less in thermal expansion coefficient.

17. The connector as set forth in claim 14, wherein the thermal expansion coefficient of the tubular sections ranges from 5 to 60 ppm/° C.

18. The connector as set forth in Claim 14, wherein the tubular sections are made by casting a resin or a composite material containing a resin and an inorganic filler.

19. The connector as set forth in claim 18, wherein the viscosity of a resin or a composite material containing a resin and an inorganic filler is 10 Pa·s or lower during the casting.

20. A method for manufacturing a microhole array with multi-holes for inserting optical fibers therethrough, comprising the steps of: disposing a first mold and a second mold having a plurality of guide holes so as to oppose the opening faces of the relevant guide holes against each other; disposing a body base material having a plurality of primary holes between the first and second molds disposed and simultaneously inserting gauge pins into guide holes of the first mold, primary holes of the body base material and guide holes of the second mold; next pouring a molding material into the gap between the first mold and the body base material and filling the molding material into the gaps between the gauge pins and the primary holes by reducing the pressure in the gap between the second mold and the body base material; extracting the gauge pins after curing said filled molding material and at the same time releasing the body base material from the molds to obtain a release product; and removing the surplus cured molding material from the obtained release product.

21. The method for manufacturing a microhole array as set forth in claim 20, wherein a molding material, 10 Pa·s or less in viscosity, is poured.
